(19) United States
(12) Patent Application Publication
(10) Pub. No.: US 2005/0255184 A1
(43) Pub. Date: Nov. 17, 2005

(54) Encased Mold Injection Molding

(76) Inventor: Arthur Newell Maupin, White Hall, IL (US)

Correspondence Address: Arthur Maupin, 132 E. Lincoln St., White Hall, IL, 62092, US

(21) Appl. No.: 10/908,462

(22) Filed: May 12, 2005

Related U.S. Application Data
(60) Provisional application No. 60/570,528, filed on May 12, 2004.

(51) Int. Cl. B29C 45/78

(52) U.S. Cl. 425/144

(57) ABSTRACT

Injection molding apparatus including a double layered mold consisting of an inner section with two or more mating parts which provide the cavity to shape the molded object and an outer section with two or more mating parts which encase the inner section and provide the rigidity to maintain the inner section cavity shape during material injection and subsequent steps in the cycle such as cooling or reaction of the material until the material is sufficiently solidified to allow removal of the outer section and continuing steps of the cycle can proceed with the inner section alone until the molded object can be removed.

This application is a non provisional of application Ser. No. 60/570,528 filed May 12, 2004.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A SEQUENCE LISTING, A TABLE, OR A COMPUTER PROGRAM LISTING

Not Applicable.

### BACKGROUND OF THE INVENTION

Injection molding of plastics and other materials is widespread but has several limitations to it's economic applicability to produce a given part. High mold/prototyping costs, setup and cooling time limit the economical run size and productivity respectively of injection molded parts. Modular molds with an inner part defining part shape and an outer part providing rigidity are available to reduce the first limitation. Apparatus with multiple molds and a single or multiple injection point(s) have also been used. An injection molding machine with a mold consisting of a fixed top part and multiple moving mating bottom parts is commercially available. This reduces cycle time by allowing part ejection, mold cleaning and insert positioning to be done while the another mold is filling but cooling must still be done while the injection mechanism is engaged. Multi-cavity family molds are also used to reduce product costs but often the difference in size and shape of the different cavities force a compromise in the parameters such as mold temperature, injection pressure and cooling time.

### BRIEF SUMMARY OF THE INVENTION

Cost of molds can be reduced by dividing them into an inner mold section (IMS) providing the part shape, cooling and ejection mechanism and an outer mold section (OMS) closely fitting around the inner section and providing the rigidity to prevent the mold cavity from undue distortion during the material injection and initial solidification to the point where the inner section can maintain the part shape. Ordinarily the IMS will be encased in the OMS during filling and packing. By indexing multiple IMS from the single. OMS to other positions after gate freeze the cooling, part removal and other steps of the mold cycle can be completed while additional parts are being filled and packed. Separate heating and cooling control can be provide to each IMS and the temperature, injection pressure, shot size and packing time can be optimized for each IMS. An IMS is fast and economical to produce compared to a complete mold so prototyping and/or short production runs are more economical.

### BRIEF DESCRIPTION OF THE DRAWINGS

FIG. 1 is a schematic sketch of the invention. 1 and 5 are the top and bottom parts of the outer mold section of the mold shown in their open positions so the inner mold section, shown as 2 and 4 can be removed. 3 is an example part to be manufactured.

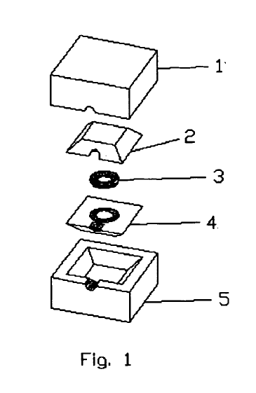

FIG. 2 is a schematic of the invention in a preferred embodiment. 6 is a rotary index machine which is used to allow multiple inner sections of the mold to be used with one outer section. In this way only the initial injection and packing steps of the process are required at the injection point (7 is the injection nozzle). Cooling, ejection, cleaning and insert addition are accomplished at other positions on the indexing machine.

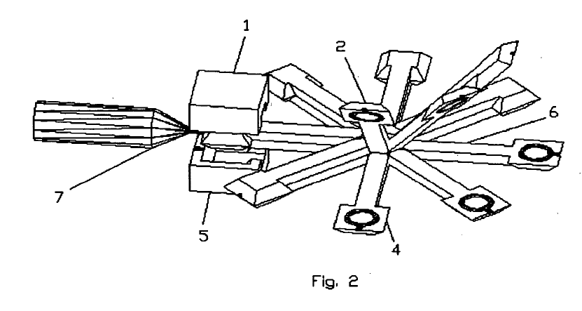

### DETAILED DESCRIPTION OF THE INVENTION

Injection molding apparatus including a double layered mold consisting of an inner mold section with two or more mating parts which provide the cavity to shape the molded object and an outer mold section with two or more mating parts which encase the inner section and provide the rigidity to maintain the inner section cavity shape during material injection and subsequent steps in the cycle such as cooling or reaction of the material until the material is sufficiently solidified to allow removal of the outer section and continuing steps of the cycle can proceed with the inner section alone until the molded object can be removed. The invention has several advantages including: reduced mold costs since only the inner mold section must be fabricated for each part; reduced prototyping cost since a prototype inner mold section can be included in a production run on full scale equipment; higher productivity since part of the cooling and other cycle time can be accomplished outside of the outer mold section; greater versatility since the inner mold section temperature can be set higher or otherwise optimized for better fill, thinner walls or lower injection pressure without decreasing productivity since available cooling time per part is increased; “Family” parts can be made at the same time and resin batch without having to use family molds; uniformity of the inner mold section's outer dimensions and it's cooling, sensor, etc. connections will allow rapid change of the inner mold section and make short production runs more economical.

1. Injection molding apparatus incorporating a double layered mold, said mold comprising: an inner mold section consisting of two or more mating parts; said inner mold section with an internal cavity defining the shape of the object to be molded, material flow and vent channels when mated together; said inner mold having an defined outer surface when mated together; an outer mold section consisting of two or more mating parts which encase the inner mold section with an defined internal surface matching the said defined outer surface of the said inner mold section when the said outer mold section is mated together; said outer mold section increasing the total strength of the mold sufficiently to provide the rigidity required during injection and initial solidification of the material being molded.

2. A system as defined in claim 1 with temperature control provided to the inner section using means such as but not limited to resistance heating or fluid heat transfer channels.

3. A system as defined in claim 2 with registration means provided to accurately join the inner mold section of the mold.

4. A system as defined in claim 3 with registration means provided to accurately encase the outer mold section of the mold around the inner mold section.

5. A system as defined in claim 4 with part ejection provided to the inner section using fluid power or mechanical means.

6. A system as defined in claim 5 with an apparatus incorporating two or more inner mold sections which can be aligned with the outer mold section at different times so that cycle steps not requiring the outer mold section can be accomplished while another inner mold section is encased in the outer mold section of the mold which is continuously attached to the injection point and the mechanism used to close and clamp the outer section of the mold.

7. A system as defined in claim 6 with automated control by computer or other means to individually control the parameters for each inner section as to temperature cycle, shot size and pressure and clamping pressure and time.

8. A system as defined in claim 4 with an apparatus incorporating two or more inner mold sections which can be aligned with the outer mold section at different times so that cycle steps not requiring the outer mold section can be accomplished while another inner mold section is encased in the outer mold section of the mold which is continuously attached to the injection point and the mechanism used to close and clamp the outer section of the mold.

9. A system as defined in claim 8 with automated control by computer or other means to individually control the parameters for each inner section as to temperature cycle, shot size and pressure and clamping pressure and time.
